(19) United States
(12) Patent Application Publication
(10) Pub. No.: US 2016/0274874 A1
(43) Pub. Date: Sep. 22, 2016

(54) METHOD AND APPARATUS FOR PROCESSING REQUEST

(71) Applicant: TENCENT TECHNOLOGY (SHENZHEN) COMPANY LIMITED, Shenzhen (CN)

(72) Inventor: MINGXING SUN, Shenzhen (CN)

(21) Appl. No.: 15/171,190

(22) Filed: Jun. 2, 2016

Related U.S. Application Data
(63) Continuation of application No. PCT/CN2015/070289, filed on Jan. 7, 2015.

(30) Foreign Application Priority Data
Jan. 8, 2014 (CN) 2014-10009271.3

(51) Int. Cl. G06F 9/44

(52) U.S. Cl. CPC G06F 8/35

(57) ABSTRACT

The present disclosure discloses a method and apparatus for processing a request. The method includes: receiving a request, where the request carries a first identifier for indicating a first module layer module located on a module layer, a second identifier for indicating a first control layer module located on a control layer, and a third identifier for indicating a first function module in the first control layer module, where the first module layer module has one or more control layer modules that include the first control layer module; acquiring the first identifier, the second identifier, and the third identifier from the request; and invoking the request and allocating the request to the first function module in the first control layer module in the first module layer module according to the first identifier, the second identifier, and the third identifier that are acquired.

### RELATED APPLICATIONS

This application claims the priority benefit of Chinese Patent Application No. 201410009271.3, entitled “METHOD AND APPARATUS FOR PROCESSING REQUEST”, filed on Jan. 8, 2014, the content of which is incorporated by reference herein in its entirety for all purposes.

### FIELD OF THE DISCLOSURE

The present disclosure relates to the Internet field and, specifically, to a method and apparatus for processing a request.

### BACKGROUND OF THE DISCLOSURE

An MVC (Model View Controller) architecture, as an existing software design architecture, is often used to organize codes. As shown in FIG. 1, in the MVC architecture, a Model layer is mainly responsible for a service logic and data processing, and integrates a service logic code and a data source code; a View layer is mainly used to display data and submit data; and a Controller is mainly used to capture a request and control forwarding of the request. The service logic uses a method of separating data and display, and the service logic is gathered in one part. In this way, a display interface may be conveniently changed or customized in a personalized manner, without rewriting the service logic. The MVC architecture is often used to map traditional input, processing, and output functions to one logical graphical user interface structure.

However, although, in the MVC architecture, the data and the display are separated from each other, a data source code and a service logic layer code inside the MVC architecture cannot be separated from each other, and the data source code is integrated in a control logic layer code, thereby causing a code structure disorder. When one service logic needs to invoke a data source in another service logic due to a change, it is necessary to rewrite the control logic layer code corresponding to the service logic, so that the rewritten control logic layer code includes a data source code corresponding to the data source in the another service logic, thereby greatly increasing complexity of code update when a service logic changes, and reducing efficiency of the code update.

In addition, the control logic layer code in the existing MVC architecture is too massive and has a high degree of coupling, which will also cause the code structure disorder. When one service logic needs to invoke a function module in another service logic due to a change, it is necessary to rewrite the control logic layer code corresponding to the service logic, so that the rewritten control logic layer code includes a function module in a control logic layer code in the another service logic, thereby greatly increasing complexity of code update when a service logic changes, and reducing efficiency of the code update.

The disclosed method and apparatus are directed to solve certain aspects of the above and other problems.

### SUMMARY

Embodiments of the present disclosure provide a method and apparatus for processing a request, to at least solve a technical problem of a code structure disorder caused by the fact that a control logic layer code inside an existing MVC architecture is too massive and has a high degree of coupling.

According to one aspect, the embodiments of the present disclosure provide a method for processing a request, including: receiving a request, where the request carries a first identifier for indicating a first module layer module located on a module layer, a second identifier for indicating a first control layer module located on a control layer, and a third identifier for indicating a first function module in the first control layer module, where the first module layer module has one or more control layer modules that include the first control layer module; acquiring the first identifier, the second identifier, and the third identifier from the request; and invoking the request and allocating the request to the first function module in the first control layer module in the first module layer module according to the first identifier, the second identifier, and the third identifier that are acquired.

Optionally, the invoking the request and allocating the request to the first function module in the first control layer module in the first module layer module according to the first identifier, the second identifier, and the third identifier that are acquired includes: searching for the first module layer module indicated by the first identifier: searching for, in the first module layer module, the first control layer module indicated by the second identifier; and invoking, in the first control layer module, the first function module indicated by the third identifier.

Optionally, the invoking, in the first control layer module, the first function module indicated by the third identifier includes: invoking a second function module in a second control layer module located on the control layer according to indication information in the first function module, where the second control layer module belongs to the control layer modules in the first module layer module, and/or, the second control layer module belongs to a control layer module in a second module layer module located on the module layer.

Optionally, the invoking, in the first control layer module, the first function module indicated by the third identifier includes: invoking a database in a DAO module located on a data layer according to indication information in the first function module, where data required for executing a service logic corresponding to the first function module is recorded in the database.

Optionally, after processing of the allocating the request to the first function module in the first control layer module in the first module layer module according to the first identifier, the second identifier, and the third identifier that are acquired, the method further includes: invoking a display function module to output a result of the processing, where the display function module includes at least one of the following: a JSON output module, an XML, output module, and a view output module.

Optionally, before the request is received, the method further includes: setting one or more module layer modules located on the module layer, where the module layer modules include the first module layer module; setting one or more control layer modules located on the control layer, where the control layer modules include the first control layer module; and setting, in each of the control layer modules, one or more function modules, where each of the function modules corresponds to one or more service logics.

Optionally, before the request is received, the method further includes: setting the DAO module located on the data layer, where data required for executing the one or more service logics is recorded in the database stored in the DAO module.

Optionally, the method further includes: different module layer modules corresponding to different applications.

Optionally, the method further includes: receiving a function module modification request; and modifying a service logic corresponding to a function module indicated by the function module modification request.

According to another aspect, the embodiments of the present disclosure further provide an apparatus for processing a request, including: a first receiving unit, configured to receive a request, where the request carries a first identifier for indicating a first module layer module located on a module layer, a second identifier for indicating a first control layer module located on a control layer, and a third identifier for indicating a first function module in the first control layer module, where the first module layer module has one or more control layer modules that include the first control layer module; an acquisition unit, configured to acquire the first identifier, the second identifier, and the third identifier from the request; and a first invoking unit, configured to invoke the request and allocate the request to the first function module in the first control layer module in the first module layer module according to the first identifier, the second identifier, and the third identifier that are acquired.

Optionally, the first invoking unit includes: a first search module, configured to search for the first module layer module indicated by the first identifier; a second search module, configured to search for, in the first module layer module, the first control layer module indicated by the second identifier; and a first invoking module, configured to invoke, in the first control layer module, the first function module indicated by the third identifier.

Optionally, the first invoking module includes: a first invoking submodule, configured to invoke a second function module in a second control layer module located on the control layer according to indication information in the first function module, where the second control layer module belongs to the control layer modules in the first module layer module, and/or, the second control layer module belongs to a control layer module in a second module layer module located on the module layer.

Optionally, the first invoking module includes: a second invoking submodule, configured to invoke a database in a DAO module located on a data layer according to indication information in the first function module, where data required for executing a service logic corresponding to the first function module is recorded in the database.

Optionally, the apparatus further includes: a second invoking unit, configured to: after processing of the allocating the request to the first function module in the first control layer module in the first module layer module according to the first identifier, the second identifier, and the third identifier that are acquired, invoke a display function module to output a result of the processing, where the display function module includes at least one of the following: a JSON output module, an XML output module, and a view output module.

Optionally, the apparatus further includes: a first setting unit, configured to: before the request is received, set one or more module layer modules located on the module layer, where the module layer modules include the first module layer module; a second setting unit, configured to set one or more control layer modules located on the control layer, where the control layer modules include the first control layer module; and a third setting unit, configured to set, in each of the control layer modules, one or more function modules, where each of the function modules corresponds to one or more service logics.

Optionally, the apparatus further includes: a fourth setting unit, configured to: before the request is received, set the DAO module located on the data layer, where data required for executing the one or more service logics is recorded in the database stored in the DAO module.

Optionally, the apparatus further includes: a second receiving unit, configured to receive a function module modification request; and a modification unit, configured to modify a service logic corresponding to a function module indicated by the function module modification request.

In the embodiments of the present application, in a layered manner, an MVC architecture is divided into a module layer, a control layer, and a data layer, and searching and invoking are performed layer by layer, so that associations between the layers are simple and independent, preventing a problem of a code structure disorder caused by that fact that a control logic layer code inside an existing MVC architecture is too massive and has a high degree of coupling. In addition, in the architecture in the embodiments of the present application, function modules in a control layer module may independently implement single logics, so that another control layer module may invoke function modules in the control layer module as required, and thus it is unnecessary to include the same function modules in multiple control layer modules, thereby greatly reducing complexity of code update, and improving efficiency of the code update. In addition, during maintenance of the function modules, it is unnecessary to maintain the multiple same function modules included in the multiple control layer modules, thereby reducing a maintenance cost, and improving maintenance efficiency. In addition, when the control layer module invokes a function module, the function module may invoke the database in the DAO module on the data layer according to an instruction, and data in the data layer is separated from the control layer module, which implements flexible invocation without rewriting a control logic layer code corresponding to the service logic, thereby greatly increasing complexity of code update when a service logic changes, and reducing efficiency of the code update.

### BRIEF DESCRIPTION OF THE DRAWINGS

Accompanying drawings described herein are used to provide a further understanding of the present disclosure, and constitute a part of the present application, and exemplary embodiments of the present disclosure and description thereof are used to explain the present disclosure, but do not constitute inappropriate limitations to the present disclosure. In the accompanying drawings:

FIG. 1 is a schematic diagram of an MVC architecture according to the related art;

FIG. 2 is a flowchart of an optional method for processing a request according to an embodiment of the present disclosure;

FIG. 3 is a flowchart of another optional method for processing a request according to an embodiment of the present disclosure;

FIG. 4 is a flowchart of still another optional method for processing a request according to an embodiment of the present disclosure;

FIG. 5 is a flowchart of still another optional method for processing a request according to an embodiment of the present disclosure;

FIG. 6 is a flowchart of still another optional method for processing a request according to an embodiment of the present disclosure;

FIG. 7 is a flowchart of still another optional method for processing a request according to an embodiment of the present disclosure;

FIG. 8 is a flowchart of still another optional method for processing a request according to an embodiment of the present disclosure;

FIG. 9 is a schematic diagram of an optional architecture according to an embodiment of the present disclosure;

FIG. 10 is a schematic diagram of another optional architecture according to an embodiment of the present disclosure;

FIG. 11 is a schematic diagram of an optional apparatus for processing a request according to an embodiment of the present disclosure;

FIG. 12 is a schematic diagram of another optional apparatus for processing a request according to an embodiment of the present disclosure;

FIG. 13 is a schematic diagram of still another optional apparatus for processing a request according to an embodiment of the present disclosure;

FIG. 14 is a schematic diagram of still another optional apparatus for processing a request according to an embodiment of the present disclosure;

FIG. 15 is a schematic diagram of still another optional apparatus for processing a request according to an embodiment of the present disclosure;

FIG. 16 is a schematic diagram of still another optional apparatus for processing a request according to an embodiment of the present disclosure;

FIG. 17 is a schematic diagram of still another optional apparatus for processing a request according to an embodiment of the present disclosure; and

FIG. 18 illustrates an exemplary computing system.

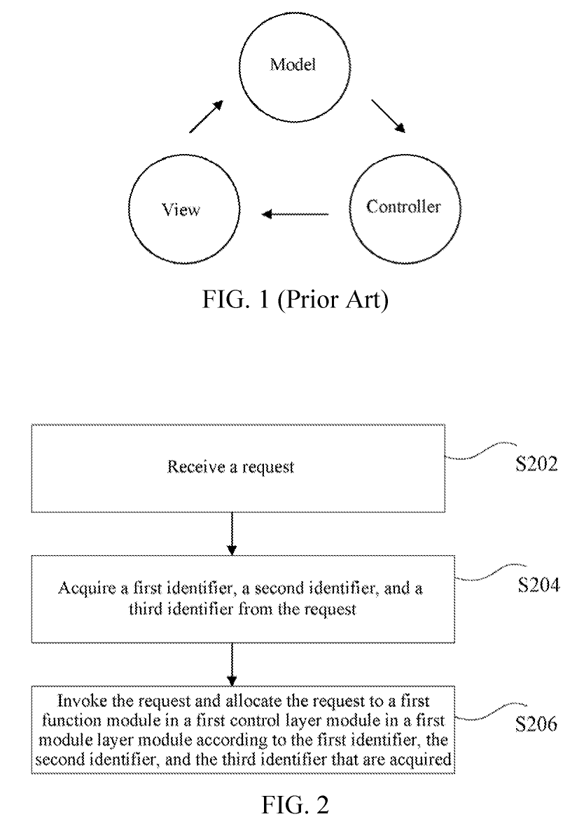

### DESCRIPTION OF EMBODIMENTS

The present disclosure is described below in detail with reference to the accompanying drawings and embodiments. It should be noted that, in case of no conflict, the embodiments in present application and characteristics in the embodiments may be combined with each other.

To make persons skilled in the art better understand the solutions of the present disclosure, the technical solution in the embodiments of the present disclosure will be described in detail below with reference to the accompanying drawings in the embodiments of the present disclosure. Apparently, the embodiments to be described are merely some rather than all of the embodiments of the present disclosure. Those embodiments derived by persons of ordinary skill in the art based on the embodiments of the present disclosure without creative efforts shall fall within the protection scope of the present disclosure.

### Embodiment 1

According to this embodiment of the present disclosure, a method for processing a request is provided, and as shown in FIG. 2, the method includes:

S202: Receiving a request, where the request carries a first identifier for indicating a first module layer module located on a module layer, a second identifier for indicating a first control layer module located on a control layer, and a third identifier for indicating a first function module in the first control layer module.

Optionally, the foregoing request may be sent by a terminal to a server. For example, a user sends, by using a Weibo client on the terminal, the foregoing request to a server that manages a Weibo application.

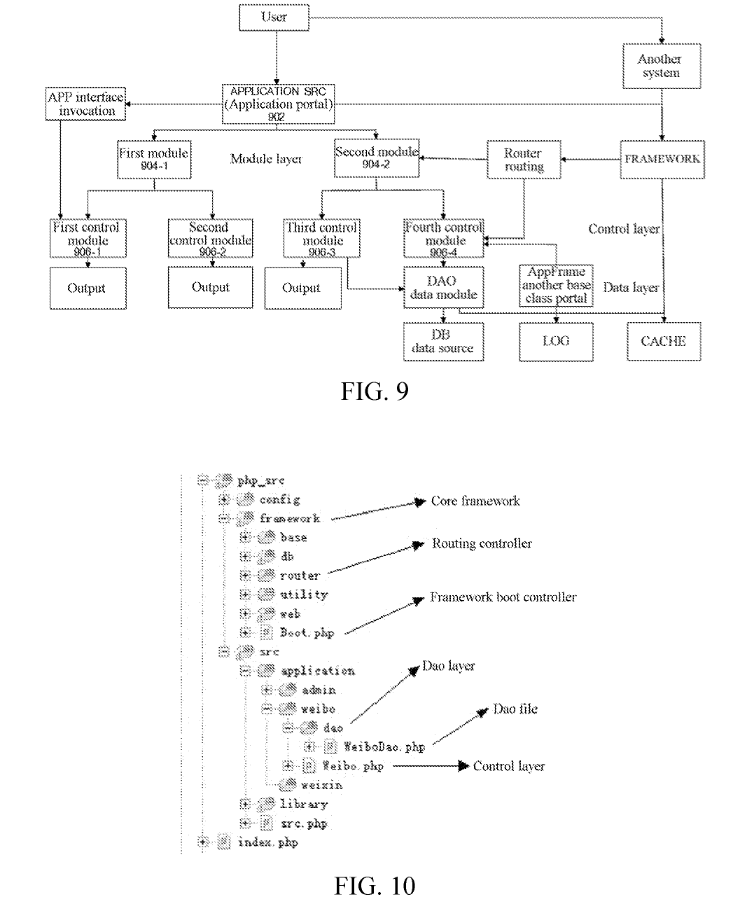

Optionally, a module architecture put forward in this embodiment is preset on the foregoing server, and as an optional example, the foregoing module architecture may be as shown in FIG. 9 and FIG. 10.

As shown in FIG. 9, the foregoing module architecture may be divided into a module layer, a control layer, and a data layer. Each module layer module located on the module layer may correspond to one application, where the foregoing application includes but is not limited to at least one of the following: WeChat and Weibo. Certainly, the module layer module in the present application is not limited thereto, and may further correspond to or represent another scenario, for example, a work department, where the work department includes but is not limited to at least one of the following: a marketing department, a purchasing department, a sales department, and a finance department.

As shown in FIG. 9, one or more module layer modules, for example, a WeChat application module or a Weibo application module, may be accessed by using an application portal. As shown in FIG. 10, each module layer module may be displayed as a folder at a certain level, for example, the Weibo application module exists, in the module architecture, in a form of a “Weibo” folder. Certainly, a form in which the module layer module exists is not limited to the folder, and forms other than the folder should also be understood as being protected by this embodiment.

Further, as shown in FIG. 9, each module layer module corresponds to one or more control layer modules, and one or more function modules are set in the control layer module located on the control layer, where each of the function modules corresponds to one or more service logics. For example, the foregoing service logics may be corresponding service logics for implementing a comment function in the Weibo application.

In addition, as shown in FIG. 10, each control layer module may be displayed as a file at a certain level, for example, a “Weibo” folder corresponding to the Weibo application module includes a “Weibo.php” file corresponding to a Weibo control layer module. Optionally, the Weibo application module includes but is not limited to the following Weibo control layer modules: a sharing control module and a comment control module. Certainly, a form in which the control layer module exists is not limited to the file, and forms other than the file should also be understood as being protected by this embodiment.

Optionally, the function module in this embodiment exists in a form of a performance function code. For example, for implementation of the comment function in the Weibo application, a function code in a “comment” file in a “Weibo” folder that implements a “comment” function may be invoked by using a request.

By use of the identifiers carried in the foregoing request, a corresponding module layer module is searched for according to the first identifier, then a corresponding control layer module is found in the module layer module according to the second identifier, then a corresponding function module in the control layer module is invoked according to the third identifier, and one function is implemented by using a performance function corresponding to the function module.

Optionally, in this embodiment, the foregoing request includes but is not limited to: a link address. For example, the request is http://domain name/index.php?m=Weibo&c=Weibo&a=_Run.

S204: Acquiring the first identifier, the second identifier, and the third identifier from the request.

Optionally, the first identifier, the second identifier, and the third identifier are acquired from the received request to search for and invoke a performance function in a corresponding module. For example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the first identifier m=Weibo, the second identifier c=Weibo, and the third identifier a=_Run may be acquired from the request.

S206: Invoking the request and allocate the request to the first function module in the first control layer module in the first module layer module according to the first identifier, the second identifier, and the third identifier that are acquired.

Optionally, after the first identifier, the second identifier, and the third identifier are acquired, the request may be invoked and allocated to the first function module in the first control layer module in the first module layer module according to the three identifiers.

For example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the first identifier m=Weibo, the second identifier c=Weibo, and the third identifier a=_Run may be acquired from this request.

It can be known according to the first identifier m=Weibo that a first module layer module Weibo is searched for and, next, it can be known according to the second identifier c=Weibo that a first control layer module Weibo in the first module layer module Weibo is searched for. Then it can be known according to the third identifier a=_Run that a performance function of _Run in the first control layer module Weibo in the first module layer module Weibo is invoked.

As shown in FIG. 10, the application portal accesses the Weibo application folder “Weibo” located on the module layer according to the foregoing request; and then accesses the “Weibo” file in the Weibo application folder “Weibo”, and invokes the performance function of _Run in the “Weibo” file.

In the embodiment provided by the present application, an MVC architecture is divided into three layers, which are a module layer, a control layer, and a data layer, and searching and invoking are performed layer by layer, so that associations between the layers are simple and independent, preventing a problem of a code structure disorder caused by the fact that a control logic layer code inside an existing MVC architecture is too massive and has a high degree of coupling. In addition, in the architecture in the embodiment of the present application, function modules in a control layer module may independently implement single logics, so that another control layer module may invoke function modules in the control layer module as required, and thus it is unnecessary to include the same function modules in multiple control layer modules, thereby greatly reducing complexity of code update, and improving efficiency of the code update.

In addition, during maintenance of the function modules, it is unnecessary to maintain the multiple same function modules included in the multiple control layer modules, thereby reducing a maintenance cost, and improving maintenance efficiency.

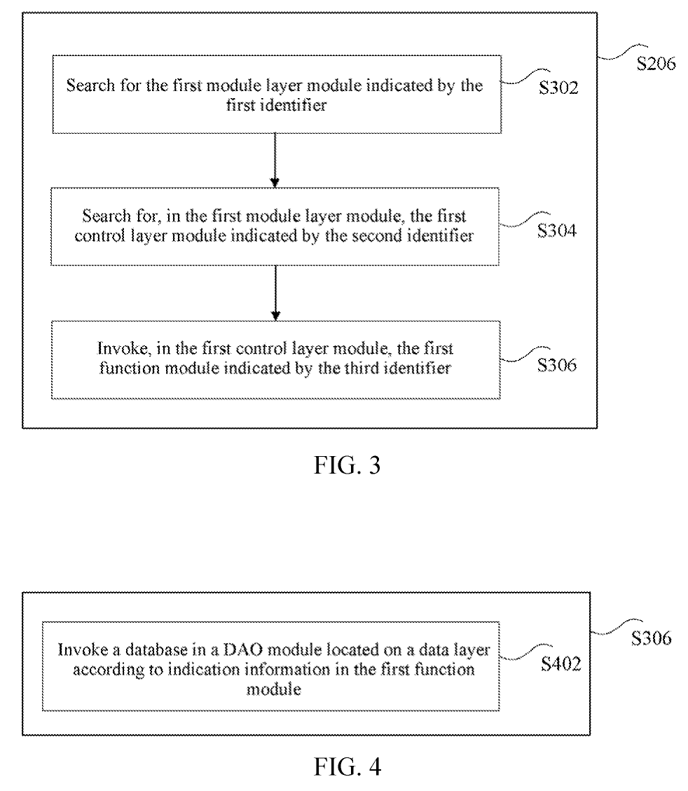

Optionally, as shown in FIG. 3, the invoking the request and allocating the request to the first function module in the first control layer module in the first module layer module according to the first identifier, the second identifier, and the third identifier that are acquired includes the following steps.

S302: Searching for the first module layer module indicated by the first identifier.

Optionally, the first identifier indicates the first module layer module, the first identifier is acquired from the received request, and then the first module layer module indicated by the first identifier is found, for example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the first identifier m=Weibo may be acquired from the request, and it can be known according to the first identifier m=Weibo that the first module layer module Weibo is searched for.

For example, the first module layer module is a Weibo application, and after the first identifier (for example, m=Weibo) is acquired, a “Weibo” folder is found according to the first identifier (for example, m=Weibo).

S304: Searching for, in the first module layer module, the first control layer module indicated by the second identifier.

Optionally, the second identifier indicates the first control layer module in the first module layer module. For example, by taking that the request includes a link address as an example, when the user sends the foregoing request by using the Weibo client on the terminal to make a request for performing a certain operation, where the link address is: http://domain name/index.php?m=Weibo&c=Weibo&a=_Run, the second identifier c=Weibo may be acquired from the request, and it can be known according to the second identifier c=Weibo that the first control layer module Weibo in the first module layer module Weibo is searched for.

For example, the first module layer module corresponds to a Weibo application, the first control layer module corresponds to a comment control module, and after the second identifier (for example, c=pinglun) is acquired, a “comment” file in the “Weibo” folder is found according to the second identifier (for example, c=pinglun).

S306: Invoking, in the first control layer module, the first function module indicated by the third identifier.

Optionally, the third identifier indicates the first function module in the first control layer module in the first module layer module, for example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the third identifier a=_Run may be acquired from the request, and it can be known according to the third identifier a=_Run that the performance function of _Run in the first control layer module Weibo in the first module layer module Weibo is invoked.

For example, the first module layer module corresponds to a Weibo application, the first control layer module corresponds to a comment control module, the first function module corresponds to a comment module, and after the third identifier (for example, a=_Run) is acquired, a corresponding function code in the “comment” file in the “Weibo” folder is invoked according to the third identifier (for example, a=_Run).

In the embodiment provided by the present application, an MVC architecture is divided into three layers, which are a module layer, a control layer, and a data layer, and searching and invoking are performed layer by layer, so that associations between the layers are simple and independent, also preventing a problem of a code structure disorder caused by the fact that a control logic layer code inside an existing MVC architecture is too massive and has a high degree of coupling.

Optionally, the invoking, in the first control layer module, the first function module indicated by the third identifier includes: invoking a second function module in a second control layer module located on the control layer according to indication information in the first function module, where the second control layer module belongs to the control layer modules in the first module layer module, and/or, the second control layer module belongs to a control layer module in a second module layer module located on the module layer.

Optionally, the invoking, in the first control layer module, the first function module indicated by the third identifier includes: invoking a second function module in a second control layer module located on the control layer according to indication information in the first function module.

Optionally, in this embodiment, the indication information in the first function module may be implemented by, but not limited to, a function, a parameter, or an instruction in a program code.

For example, the first control layer module is a comment control module, the second control layer module is a sharing control module, and the comment control module and the sharing control module belong to the same Weibo application module. That is, files corresponding to the comment control module and the sharing control module are both located in a folder corresponding to the Weibo application module.

In this embodiment, the comment control module invokes the first function module indicated by the third identifier, for example, a “comment” performance function, where the first function module indicates invocation of the second function module in the sharing control module, for example, a function code that implements a “sharing” function, and then “sharing” can be implemented while “comment” is implemented.

Optionally, in this embodiment, the second control layer module includes but is not limited to at least one of the following: belonging to the control layer modules in the first module layer module, and belonging to a control layer module in a second module layer module located on the module layer.

For example, the first module layer module corresponds to a WeChat application, the second module layer module corresponds to a Weibo application, the first control layer module is a comment control module, the second control layer module is a sharing control module, and in this embodiment, the sharing control module may belong to the first module layer module where the WeChat application is located, and may also belong to the second module layer module where the Weibo application is located.

In the embodiment provided by the present application, an MVC architecture is divided into three layers, which are a module layer, a control layer, and a data layer, and searching and invoking are performed layer by layer, so that associations between the layers are simple and independent, preventing a problem of a code structure disorder caused by the fact that a control logic layer code inside an existing MVC architecture is too massive and has a high degree of coupling. In addition, in the architecture in the embodiment of the present application, function modules in a control layer module may independently implement single logics, so that another control layer module may invoke function modules in the control layer module as required, and thus it is unnecessary to include the same function modules in multiple control layer modules, thereby greatly reducing complexity of code update, and improving efficiency of the code update.

In addition, during maintenance of the function modules, it is unnecessary to maintain the multiple same function modules included in the multiple control layer modules, thereby reducing a maintenance cost, and improving maintenance efficiency.

Optionally, as shown in FIG. 4, the invoking, in the first control layer module, the first function module indicated by the third identifier includes the following steps.

S402: Invoking a database in a DAO module located on a data layer according to indication information in the first function module.

Optionally, in this embodiment, the database includes but is not limited to: data required for executing a service logic corresponding to the first function module.

Optionally, in this embodiment, the data required by the service logic includes but is not limited to at least one of the following: user information, a historical record, and a service form.

For example, user information, for example, a friend list, in the DAO module on the data layer is invoked according to indication information in a “comment”, so as to “@” a friend during commenting.

In the embodiment provided by the present application, when the control layer module invokes a function module, the function module may invoke the database in the DAO module on the data layer according to an instruction, and data in the data layer is separated from the control layer module, which implements flexible invocation without rewriting a control logic layer code corresponding to the service logic, thereby greatly increasing complexity of code update when a service logic changes, and reducing efficiency of the code update.

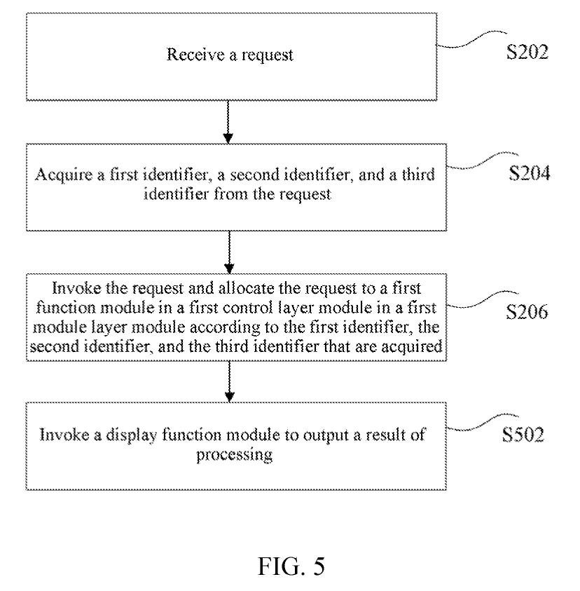

Optionally, as shown in FIG. 5, after processing of the allocating the request to the first function module in the first control layer module in the first module layer module according to the first identifier, the second identifier, and the third identifier that are acquired, the method further includes the following step(s).

S502: Invoking a display function module to output a result of the processing.

Optionally, in this embodiment, the display function module includes but is not limited to at least one of the following: a JSON output module, an XML output module, and a view output module.

For example, the first module layer module corresponds to a Weibo application, the first control layer module corresponds to a comment control module, and the first function module corresponds to a comment module. In this embodiment, after a corresponding performance function in the comment control module in the Weibo application is invoked according to the first identifier, the second identifier, and the third identifier that are acquired, the display function module is invoked. For example, a view is outputted to display a comment result in a view form.

In the embodiment provided by the present application, a display function module is invoked to output a result of the processing, which can make a user conveniently see the processing result of the request more intuitively.

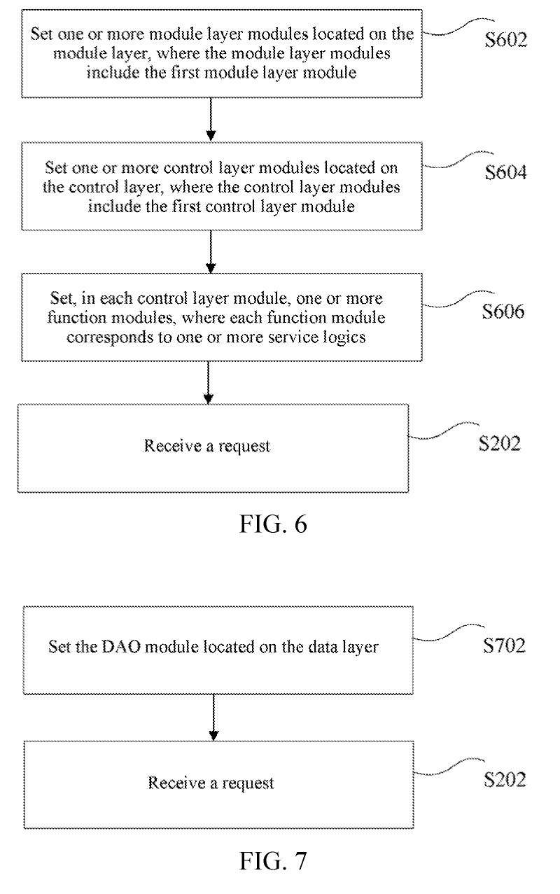

Optionally, as shown in FIG. 6, before the request is received, the method further includes the following step(s).

S602: Setting one or more module layer modules located on the module layer, where the module layer modules include the first module layer module.

Optionally, to construct the foregoing architecture, one or more module layer modules located on the module layer may be set. Optionally, in this embodiment, a module on the module layer includes but is not limited to at least one of the following: a single application and a work department. The single application includes but is not limited to at least one of the following: WeChat and Weibo. The work department includes but is not limited to at least one of the following: a marketing department, a purchasing department, a sales department, and a finance department.

Optionally, in this embodiment, in the received request, the module on the module layer exists in a folder form. For example, a Weibo application module exists, in the architecture, in a form of a “Weibo” folder.

S604: Setting one or more control layer modules located on the control layer, where the control layer modules include the first control layer module.

Optionally, to construct the foregoing architecture, one or more control layer modules located on the control layer may be set. In this embodiment, each module layer module may include one or more control layer modules, for example, the Weibo module includes but is not limited to: a sharing control module and a comment control module.

Optionally, in this embodiment, the module on the control layer exists in a file form. For example, the comment function in the Weibo application exists in a form of a “comment” file in the “Weibo” folder.

S606: Setting, in each of the control layer modules, one or more function modules, where each of the function modules corresponds to one or more service logics.

Optionally, to construct the foregoing architecture, one or more function modules may be set in each control layer module. For example, a comment includes but is not limited to: a comment, a praise, and a forwarding.

Optionally, each function module corresponds to one or more service logics. For example, a performance function of a comment includes but is not limited to: sending and receiving.

Optionally, in this embodiment, the function module exists in a form of a performance function code. For example, the comment function in the Weibo application is implemented by invoking a function code of the “comment” function in the “comment” file in the “Weibo” folder.

In the embodiment provided by the present application, an MVC architecture with three layers, which are a module layer, a control layer, and a data layer, is constructed, data on the data layer is separated from a control layer module, independency thereof is enhanced, and at the same time, complexity of code update when a service logic changes is further greatly increased, and efficiency of the code update is reduced.

Optionally, as shown in FIG. 7, before the request is received, the method further includes the following step(s).

S702: Setting the DAO module located on the data layer.

Optionally, to construct the foregoing architecture, the DAO module located on the data layer may be set.

Optionally, in this embodiment, the DAO module includes but is not limited to: a stored database that records data required for executing one or more service logics.

Optionally, in this embodiment, the data required by the service logic includes but is not limited to at least one of the following: user information, a historical record, and a service form.

For example, the DAO module on the data layer stores user information, for example, a friend list, so as to “@” a friend during commenting.

In the embodiment provided by the present application, data set on a data layer is separated from a control layer module, which solves a problem of a code structure disorder caused by an operation of integrating data sources inside a module in an existing MVC architecture.

Optionally, different module layer modules correspond to different applications.

Optionally, the module layer module includes but is not limited to at least one of the following applications: WeChat and Weibo.

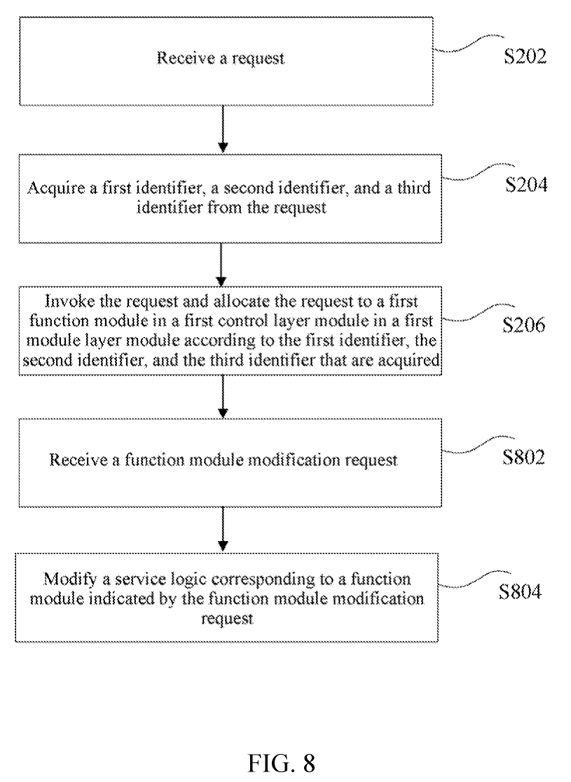

Optionally, as shown in FIG. 8, the method further includes the following step(s).

S802: Receiving a function module modification request.

Optionally, the function module modification request is received, for example, the first module layer module corresponds to a Weibo application, the first control layer module corresponds to a comment control module, the first function module corresponds to a comment module, and in this embodiment, a corresponding modification may be performed on a performance function code in the comment module according to the modification request.

S804: Modifying a service logic corresponding to a function module indicated by the function module modification request.

Optionally, after the function module modification request is received, a service logic corresponding to an indicated function module is modified. For example, a service logic of “receiving an image of 20k” is modified as a service logic of “receiving an image of 40k”, or a service logic of “sending once every 10 s” is modified as a service logic of “sending once every 5 s”.

In the embodiment provided by the present application, real-time modification on a function module and a service logic corresponding to the function module is implemented, which makes it easier to meet a customer requirement.

Optionally, a schematic diagram of an architecture of the method is as shown in FIG. 9, and the entire architecture consists of a module layer, a control layer, and a data layer.

As shown in FIG. 9, a processing flow of the architecture is as follows: after a client initiates a request, a user first enters an application layer portal 902 to perform unified scheduling, and then allocates, by using a Router routing mechanism of a framework, the request into a specified module layer (for example, a first module 904-1)→a specified control layer (for example, a first control layer 906-1)→a specified performance function for execution. For example, an address of the request is: http://domain name/index.php?m=Weibo&c=Weibo&a=_Run, and the router automatically allocates the request into a _Run function in a Weibo control layer in a Weibo module for arithmetic processing.

Optionally, the module layer includes one or more module layer modules, for example, a first module layer module 904-1 and a second module layer module 904-2. Optionally, the control layer includes one or more control layer modules, for example, a first control layer module 906-1, a second control layer module 906-2, a third control layer module 906-3, and a fourth control layer module 906-4.

Optionally, the entire architecture can be freely expanded and controlled according to traffic volume, and multiple control layer modules are integrated inside each module layer module, for example, the first module layer module 904-1 may include the first control layer module 906-1 and the second control layer module 906-2. All logic parts are placed on the control layer for implementation, and all intra-layer application functions embody single atomicity, fully implementing an idea of an advanced architecture with high cohesion and loose coupling.

Optionally, the module layer does not relate to storage of one SQL or one file, and all DB data sources are placed in the DAO module on the data layer to for unified processing, which can thus ensure independency of a data interface source and strong reusability, enabling the data interface source to be invoked by any control layer control module of all modules in the entire system as required.

Optionally, all framework services are allocated in a unified manner by using a Boot.php portal, and that a file contains loaded unified deployment is easily implemented by using a path namespace mechanism. Many advanced ideas and mechanisms such as java and C++ are integrated into the present disclosure, which performs subentry split operations without losing strong wholeness.

It should be noted that, for the foregoing method embodiments, for ease and simple description, each method embodiment is described as a combination of a series of actions. However, persons skilled in the art should know that, the present disclosure is not limited by the described action sequence, because, according to the present disclosure, some steps can be performed in another sequence or synchronously. Secondly, persons skilled in the art should also know that, all the embodiments described in the specification are preferred embodiments, and the involved actions and modules are not necessarily required by the present disclosure.

Through the foregoing description of the embodiments, persons skilled in the art can clearly understand that the method according to the foregoing embodiments may be implemented by software on a necessary universal hardware platform, and definitely may also be implemented by hardware. However, under most circumstances, the former is preferred. Based on such an understanding, the technical solutions of the present disclosure essentially or the part that makes contributions to the related art may be embodied in a form of a software product. The computer software product is stored in one storage medium (such as an ROM/RAM, a magnetic disk, and an optical disc), and includes several instructions for instructing a terminal device (which may be a mobile phone, a computer, a server, or a network device) to perform the methods described in the embodiments of the present disclosure.

### Embodiment 2

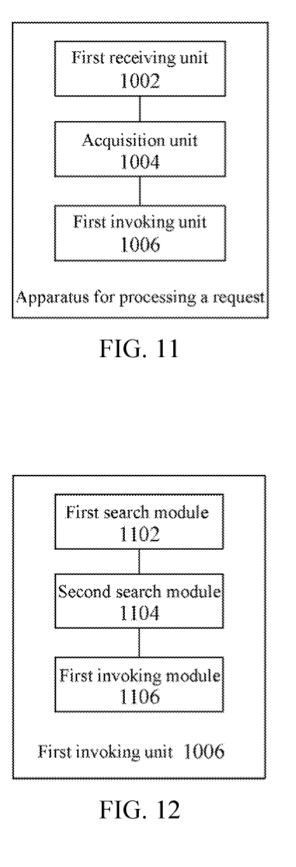

According to this embodiment of the present disclosure, an apparatus for processing a request is further provided, and as shown in FIG. 11, the apparatus for processing a request in this embodiment includes a first receiving unit 1002, an acquisition unit 1004, and a first invoking unit 1006, etc.

The first receiving unit 1002 may be configured to receive a request, where the request carries a first identifier for indicating a first module layer module located on a module layer, a second identifier for indicating a first control layer module located on a control layer, and a third identifier for indicating a first function module in the first control layer module. The first module layer module has one or more control layer modules that include the first control layer module.

Optionally, the foregoing request may be sent by a terminal to a server, for example, a user sends, by using a Weibo client on the terminal, the foregoing request to a server that manages a Weibo application.

Optionally, a module architecture put forward in this embodiment is preset on the foregoing server, and as an optional example, the foregoing module architecture may be as shown in FIG. 9 and FIG. 10.

As shown in FIG. 9, the foregoing module architecture may be divided into a module layer, a control layer, and a data layer. Each module layer module located on the module layer may correspond to one application, where the foregoing application includes but is not limited to at least one of the following: WeChat and Weibo. Certainly, the module layer module in the present application is not limited thereto, and may further correspond to or represent another scenario, for example, a work department, where the work department includes but is not limited to at least one of the following: a marketing department, a purchasing department, a sales department, and a finance department.

As shown in FIG. 9, one or more module layer modules, for example, a WeChat application module or a Weibo application module, may be accessed by using an application portal, and in FIG. 10, each module layer module may be displayed as a folder at a certain level, for example, the Weibo application module exists, in the module architecture, in a form of a “Weibo” folder. Certainly, a form in which the module layer module exists is not limited to the folder, and forms other than the folder should also be understood as being protected by this embodiment.

Further, as shown in FIG. 9, each module layer module corresponds to one or more control layer modules, and one or more function modules are set in the control layer module located on the control layer, where each of the function modules corresponds to one or more service logics, for example, the foregoing service logics may be corresponding service logics for implementing a comment function in the Weibo application.

In addition, as shown in FIG. 10, each control layer module may be displayed as a file at a certain level, for example, a “Weibo” folder corresponding to the Weibo application module includes a “Weibo.php” file corresponding to a Weibo control layer module. Optionally, the Weibo application module includes but is not limited to the following Weibo control layer modules: a sharing control module and a comment control module. Certainly, a form in which the control layer module exists is not limited to the file, and forms other than the file should also be understood as being protected by this embodiment.

Optionally, the function module in this embodiment exists in a form of a performance function code. For example, for implementation of the comment function in the Weibo application, a function code in a “comment” file in a “Weibo” folder that implements a “comment” function may be invoked by using a request.

By use of the identifiers carried in the foregoing request, a corresponding module layer module is searched for according to the first identifier, then a corresponding control layer module is found in the module layer module according to the second identifier, then a corresponding function module in the control layer module is invoked according to the third identifier, and one function is implemented by using a performance function corresponding to the function module.

Optionally, in this embodiment, the foregoing request includes but is not limited to: a link address. For example, the request is http://domain name/index.php?m=Weibo&c=Weibo&a=_Run.

Returning to FIG. 9, the acquisition unit 1004 may be configured to acquire the first identifier, the second identifier, and the third identifier from the request.

Optionally, the first identifier, the second identifier, and the third identifier are acquired from the received request to search for and invoke a performance function in a corresponding module. For example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the first identifier m=Weibo, the second identifier c=Weibo, and the third identifier a=_Run may be acquired from this request.

The first invoking unit 1006 may be configured to invoke the request and allocate the request to the first function module in the first control layer module in the first module layer module according to the first identifier, the second identifier, and the third identifier that are acquired.

Optionally, after the first identifier, the second identifier, and the third identifier are acquired, the request may be invoked and allocated to the first function module in the first control layer module in the first module layer module according to the three identifiers.

For example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the first identifier m=Weibo, the second identifier c=Weibo, and the third identifier a=_Run may be acquired from this request.

It can be known according to the first identifier m=Weibo that a first module layer module Weibo is searched for, next it can be known according to the second identifier c=Weibo that a first control layer module Weibo in the first module layer module Weibo is searched for, and then it can be known according to the third identifier a=_Run that a performance function of _Run in the first control layer module Weibo in the first module layer module Weibo is invoked.

As shown in FIG. 10, the application portal accesses the Weibo application folder “Weibo” located on the module layer according to the foregoing request; and then accesses the “Weibo” file in the Weibo application folder “Weibo”, and invokes the performance function of _Run in the “Weibo” file.

In the embodiment of the present application, an MVC architecture is divided into three layers, which are a module layer, a control layer, and a data layer, and searching and invoking are performed layer by layer, so that associations between the layers are simple and independent, preventing a problem of a code structure disorder caused by that fact that a control logic layer code inside an existing MVC architecture is too massive and has a high degree of coupling. In addition, in the architecture in the embodiment of the present application, function modules in a control layer module may independently implement single logics, so that another control layer module may invoke function modules in the control layer module as required, and thus it is unnecessary to include the same function modules in multiple control layer modules, thereby greatly reducing complexity of code update, and improving efficiency of the code update.

In addition, during maintenance of the function modules, it is unnecessary to maintain the multiple same function modules included in the multiple control layer modules, thereby reducing a maintenance cost, and improving maintenance efficiency.

Optionally, as shown in FIG. 12, the first invoking unit 1006 includes a first search module 1102, a second search module 1104, and a first invoking module 1106, etc.

The first search module 1102 may be configured to search for the first module layer module indicated by the first identifier.

Optionally, the first identifier indicates the first module layer module, the first identifier is acquired from the received request, and then the first module layer module indicated by the first identifier is found, for example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the first identifier m=Weibo may be acquired from the request, and it can be known according to the first identifier m=Weibo that the first module layer module Weibo is searched for.

For example, the first module layer module is a Weibo application, and after the first identifier (for example, m=Weibo) is acquired, a “Weibo” folder is found according to the first identifier (for example, m=Weibo).

The second search module 1104 may be configured to search for, in the first module layer module, the first control layer module indicated by the second identifier.

Optionally, the second identifier indicates the first control layer module in the first module layer module, for example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the second identifier c=Weibo may be acquired from the request, and it can be known according to the second identifier c=Weibo that the first control layer module Weibo in the first module layer module Weibo is searched for.

For example, the first module layer module corresponds to a Weibo application, the first control layer module corresponds to a comment control module, and after the second identifier (for example, c=pinglun) is acquired, a “comment” file in the “Weibo” folder is found according to the second identifier (for example, c=pinglun).

The first invoking module 1106 may be configured to invoke, in the first control layer module, the first function module indicated by the third identifier.

Optionally, the third identifier indicates the first function module in the first control layer module in the first module layer module, for example, by taking that the request includes a link address as an example, when the user sends the foregoing request by using the Weibo client on the terminal, to make a request for performing a certain operation, where the link address is: http://domain name/index.php?m=Weibo&c=Weibo&a=_Run, the third identifier a=_Run may be acquired from the request, and it can be known according to the third identifier a=_Run that the performance function of _Run in the first control layer module Weibo in the first module layer module Weibo is invoked.

For example, the first module layer module corresponds to a Weibo application, the first control layer module corresponds to a comment control module, the first function module corresponds to a comment module, and after the third identifier (for example, a=_Run) is acquired, a corresponding function code in the “comment” file in the “Weibo” folder is invoked according to the third identifier (for example, a=_Run).

In the embodiment of the present application, an MVC architecture is divided into three layers, which are a module layer, a control layer, and a data layer, and searching and invoking are performed layer by layer, so that associations between the layers are simple and independent, also preventing a problem of a code structure disorder caused by that fact that a control logic layer code inside an existing MVC architecture is too massive and has a high degree of coupling.

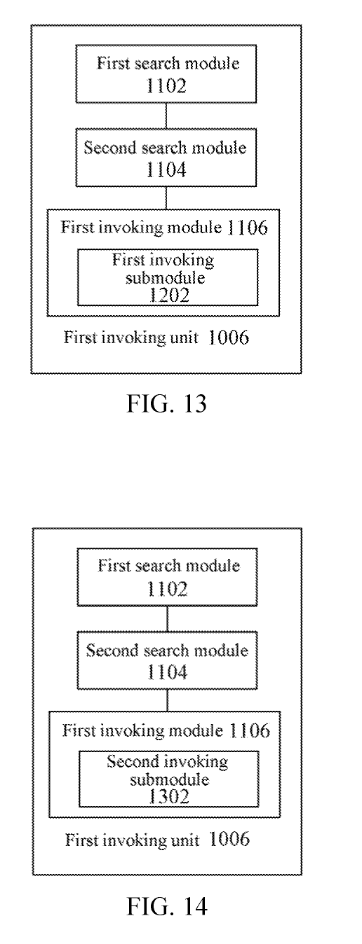

Optionally, as shown in FIG. 13, the first invoking module 1106 includes a first invoking submodule 1202,

The first invoking submodule 1202 may configured to invoke a second function module in a second control layer module located on the control layer according to indication information in the first function module, where the second control layer module belongs to the control layer modules in the first module layer module, and/or, the second control layer module belongs to a control layer module in a second module layer module located on the module layer.

Optionally, the invoking, in the first control layer module, the first function module indicated by the third identifier includes: invoking a second function module in a second control layer module located on the control layer according to indication information in the first function module.

Optionally, in this embodiment, the indication information in the first function module may be implemented by, but not limited to, a function, a parameter, or an instruction in a program code.

For example, the first control layer module is a comment control module, the second control layer module is a sharing control module, and the comment control module and the sharing control module belong to the same Weibo application module, that is, files corresponding to the comment control module and the sharing control module are both located in a folder corresponding to the Weibo application module.

In this embodiment, the comment control module invokes the first function module indicated by the third identifier, for example, a “comment” performance function, where the first function module indicates invocation of the second function module in the sharing control module, for example, a function code that implements a “sharing” function, and then “sharing” can be implemented while “comment” is implemented.

Optionally, in this embodiment, the second control layer module includes but is not limited to at least one of the following: belonging to the control layer modules in the first module layer module, and belonging to a control layer module in a second module layer module on the module layer.

For example, the first module layer module corresponds to a WeChat application, the second module layer module corresponds to a Weibo application, the first control layer module is a comment control module, the second control layer module is a sharing control module, and in this embodiment, the sharing control module may belong to the first module layer module where the WeChat application is located, and may also belong to the second module layer module where the Weibo application is located.

In the embodiment of the present application, an MVC architecture is divided into three layers, which are a module layer, a control layer, and a data layer, and searching and invoking are performed layer by layer, so that associations between the layers are simple and independent, preventing a problem of a code structure disorder caused by that fact that a control logic layer code inside an existing MVC architecture is too massive and has a high degree of coupling. In addition, in the architecture in the embodiment of the present application, function modules in a control layer module may independently implement single logics, so that another control layer module may invoke function modules in the control layer module as required, and thus it is unnecessary to include the same function modules in multiple control layer modules, thereby greatly reducing complexity of code update, and improving efficiency of the code update.

In addition, during maintenance of the function modules, it is unnecessary to maintain the multiple same function modules included in the multiple control layer modules, thereby reducing a maintenance cost, and improving maintenance efficiency.

Optionally, as shown in FIG. 14, the first invoking module 1106 includes a second invoking submodule 1302.

The second invoking submodule 1302 may be configured to invoke a database in a DAO module located on a data layer according to indication information in the first function module, where data required for executing a service logic corresponding to the first function module is recorded in the database.

Optionally, in this embodiment, the database includes but is not limited to: data required for executing a service logic corresponding to the first function module.

Optionally, in this embodiment, the data required by the service logic includes but is not limited to at least one of the following: user information, a historical record, and a service form.

For example, user information, for example, a friend list, in the DAO module on the data layer is invoked according to indication information in a “comment”, so as to “@” a friend during commenting.

In the embodiment provided by the present application, when the control layer module invokes a function module, the function module may invoke the database in the DAO module on the data layer according to an instruction, and data in the data layer is separated from the control layer module, which implements flexible invocation without rewriting a control logic layer code corresponding to the service logic, thereby greatly increasing complexity of code update when a service logic changes, and reducing efficiency of the code update.

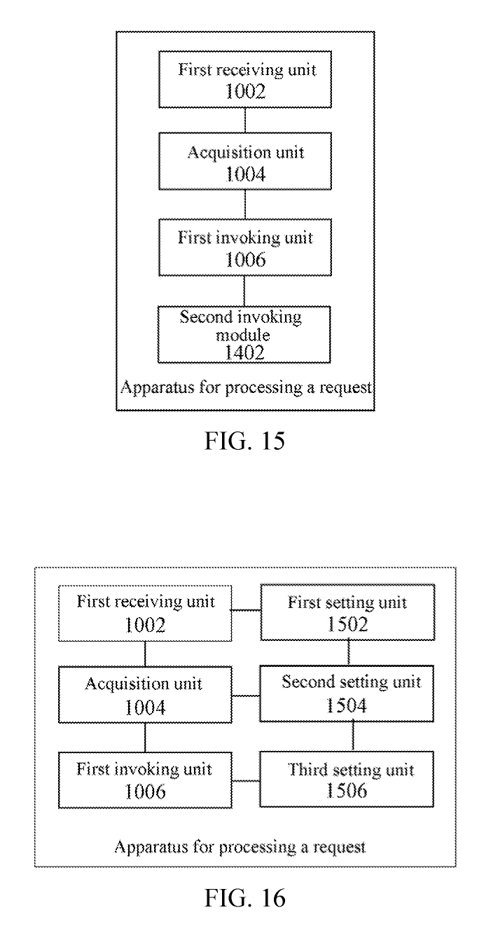

Optionally, as shown in FIG. 15, in this embodiment, the apparatus for processing a request further includes a second invoking unit 1402.

The second invoking unit 1402 may be configured to: after processing of the allocating the request to the first function module in the first control layer module in the first module layer module according to the first identifier, the second identifier, and the third identifier that are acquired, invoke a display function module to output a result of the processing.

Optionally, in this embodiment, the display function module includes but is not limited to at least one of the following: a JSON output module, an XML output module, and a view output module.

For example, the first module layer module corresponds to a Weibo application, the first control layer module corresponds to a comment control module, the first function module corresponds to a comment module, and in this embodiment, after a corresponding performance function in the comment control module in the Weibo application is invoked according to the first identifier, the second identifier, and the third identifier that are acquired, the display function module is invoked, for example, a view is output, to display, in a view form, a comment result.

In the embodiment provided by the present application, a display function module is invoked to output a result of the processing, which can make a user conveniently see the processing result of the request more intuitively.

Optionally, as shown in FIG. 16, in this embodiment, the apparatus for processing a request further includes a first setting unit 1502, a second setting unit 1504, and a third setting unit 1506, etc.

The first setting unit 1502 may be configured to: before the request is received, set one or more module layer modules located on the module layer, where the module layer modules include the first module layer module.

Optionally, to construct the foregoing architecture, one or more module layer modules located on the module layer may be set. Optionally, in this embodiment, a module on the module layer includes but is not limited to at least one of the following: a single application and a work department. The single application includes but is not limited to at least one of the following: WeChat and Weibo. The work department includes but is not limited to at least one of the following: a marketing department, a purchasing department, a sales department, and a finance department.

Optionally, in this embodiment, in the received request, the module on the module layer exists in a folder form. For example, a Weibo application module exists, in the architecture, in a form of a “Weibo” folder.

The second setting unit 1504 may be configured to set one or more control layer modules located on the control layer, where the control layer modules include the first control layer module.

Optionally, to construct the foregoing architecture, one or more control layer modules located on the control layer may be set. In this embodiment, each module layer module may include one or more control layer modules, for example, the Weibo module includes but is not limited to: a sharing control module and a comment control module.

Optionally, in this embodiment, the module on the control layer exists in a file form. For example, the comment function in the Weibo application exists in a form of a “comment” file in the “Weibo” folder.

The third setting unit 1506 may be configured to set, in each of the control layer modules, one or more function modules, where each of the function modules corresponds to one or more service logics.

Optionally, to construct the foregoing architecture, one or more function modules may be set in each control layer module. For example, a comment includes but is not limited to: a comment, a praise, and a forwarding.

Optionally, each function module corresponds to one or more service logics. For example, a performance function of a comment includes but is not limited to: sending and receiving.

Optionally, in this embodiment, the function module exists in a form of a performance function code. For example, the comment function in the Weibo application is implemented by invoking the function code of the “comment” function in the “comment” file in the “Weibo” folder.

In the embodiment provided by the present application, an MVC architecture with three layers, which are a module layer, a control layer, and a data layer, is constructed, data on the data layer is separated from a control layer module, independency thereof is enhanced, and at the same time, complexity of code update when a service logic changes is further greatly increased, and efficiency of the code update is reduced.

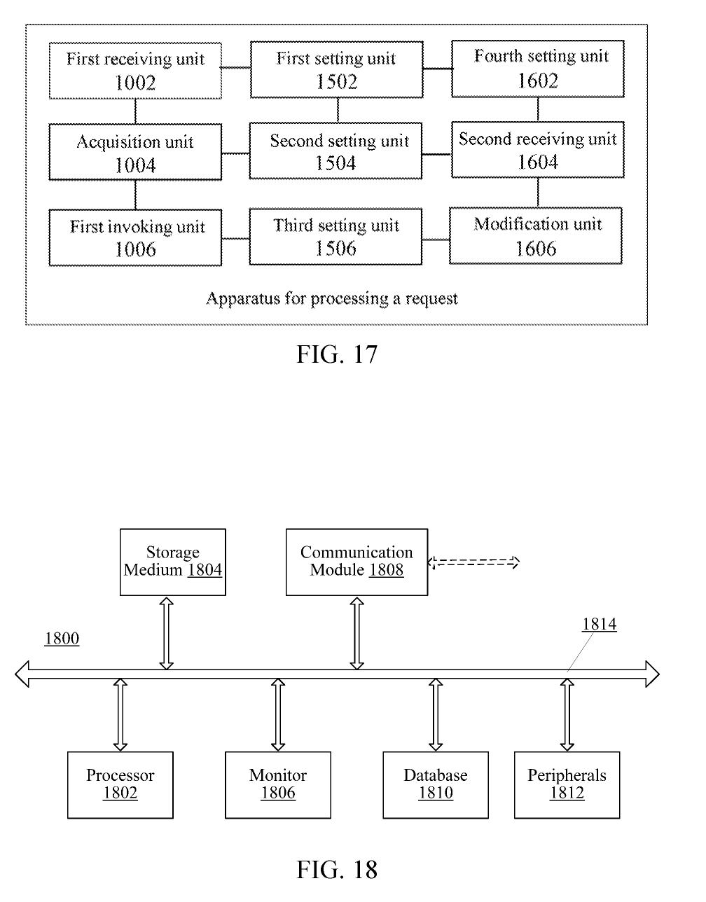

Optionally, as shown in FIG. 17, in this embodiment, the apparatus for processing a request further includes a fourth setting unit 1602.

The fourth setting unit 1602 may be configured to: before the request is received, set the DAO module located on the data layer, where data required for executing the one or more service logics is recorded in the database stored in the DAO module.

Optionally, to construct the foregoing architecture, the DAO module located on the data layer may be set.

Optionally, in this embodiment, the DAO module includes but is not limited to: a stored database that records data required for executing one or more service logics.

Optionally, in this embodiment, the data required by the service logic includes but is not limited to at least one of the following: user information, a historical record, and a service form.

For example, the DAO module on the data layer stores user information, for example, a friend list, so as to “@” a friend during commenting.

In the embodiment provided by the present application, data set on a data layer is separated from a control layer module, which solves a problem of a code structure disorder caused by an operation of integrating data sources inside a module in an existing MVC architecture.

Optionally, as shown in FIG. 17, in this embodiment, the apparatus for processing a request further includes a second receiving unit 1604 and a modification unit 1606.

The second receiving unit 1604 may be configured to receive a function module modification request.

Optionally, the function module modification request is received, for example, the first module layer module corresponds to a Weibo application, the first control layer module corresponds to a comment control module, the first function module corresponds to a comment module, and in this embodiment, a corresponding modification may be performed on a performance function code in the comment module according to the modification request.

The modification unit 1606 may be configured to modify a service logic corresponding to a function module indicated by the function module modification request.

Optionally, after the function module modification request is received, a service logic corresponding to an indicated function module is modified. For example, a service logic of “receiving an image of 20k” is modified as a service logic of “receiving an image of 40k”, or a service logic of “sending once every 10 s” is modified as a service logic of “sending once every 5 s”.

The server, the terminal, and/or the various modules/submodules/units may be implemented in one or more computing systems. FIG. 18 illustrates an exemplary computing system.

As shown in FIG. 18, computing system 1800 may include a processor 1802, a storage medium 1804, a monitor 1806, a communication module 1808, a database 1810, peripherals 1812, and one or more bus 1814 to couple the devices together. Certain devices may be omitted and other devices may be included.

The processor 1802 can include any appropriate processor or processors. Further, the processor 1802 can include multiple cores for multi-thread or parallel processing. The storage medium 1804 may include memory modules, e.g., Read-Only Memory (ROM), Random Access Memory (RAM), and flash memory modules, and mass storages, e.g., CD-ROM, U-disk, removable hard disk, etc. The storage medium 1804 may store computer programs for implementing various processes (e.g. hosting application programs for different services, maintaining various modules located in different module layers, invoking a request and allocating the request to one or more of the various modules, modifying a service logic, modifying a function module, etc.), when executed by the processor 1802.

The monitor 1806 may include display devices for displaying contents in the computing system 1800. A display function module may process and present the content, such as displaying texts or media contents through a messaging application or microblog application installed on the computing system 1800. The peripherals 1812 may include I/O devices, e.g., keyboard and mouse for inputting information by a user. The peripherals may also include certain sensors, such as gravity sensors, acceleration sensors, and other types of sensors.

Further, the communication module 1808 may include network devices for establishing connections through a communication network. The database 1810 may include one or more databases for storing certain data and for performing certain operations on the stored data, such as storing data required for executing various service logics.

In operation, the terminal and/or the server may implement real-time modification on a function module and a service logic corresponding to the function module. The terminal and/or the server may be configured to provide structures and functions correspondingly for related actions and operations.

In the embodiment provided by the present application, real-time modification on a function module and a service logic corresponding to the function module is implemented, which makes it easier to meet a customer requirement.

The foregoing sequence numbers of the embodiments of the present disclosure are merely for the convenience of description, and do not imply the preference among the embodiments.

In the foregoing embodiments of the present disclosure, the description of each embodiment has its own focus; for the content that is not detailed in a certain embodiment, reference can be made to the relevant description of another embodiment.

In the several embodiments provided in the present application, it should be understood that the disclosed client may be implemented in another manner. The described apparatus embodiments are only exemplary. For example, division of the unit is merely division of a logical function and division in another manner may exist in actual implementation, for example, a plurality of units or components may be combined or integrated into another system, or some features may be ignored or not performed. In addition, the mutual coupling or direct coupling or communication connections displayed or discussed may be implemented by using some interfaces, and the indirect coupling or communication connections between the units or modules may be implemented electrically or in another form.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, the functional units in the embodiments of the present disclosure may be integrated into one processing unit, or each of the units may exist alone physically, or two or more units are integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part that makes contributions to the related art, or all or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present disclosure. The foregoing storage medium includes: any medium that can store a program code, such as a USB flash drive, a Read-Only Memory (ROM), a Random Access Memory (RAM), a removable hard disk, a magnetic disk, or an optical disc.

The foregoing descriptions are only preferred embodiments of the present disclosure. It should be noted by persons of ordinary skill in the art that several improvements and modifications may be made without departing from the principle of the present disclosure, which should be construed as falling within the protection scope of the present disclosure.

1. A method for processing a request, comprising:
receiving a request, wherein the request carries a first identifier for indicating a first module layer module located on a module layer, a second identifier for indicating a first control layer module located on a control layer, and a third identifier for indicating a first function module in the first control layer module, wherein the first module layer module has one or more control layer modules that comprise the first control layer module;
acquiring the first identifier, the second identifier, and the third identifier from the request; and
invoking the request and allocating the request to the first function module in the first control layer module in the first module layer module according to the first identifier, the second identifier, and the third identifier that are acquired.

2. The method according to claim 1, wherein the invoking the request and allocating the request to the first function module in the first control layer module in the first module layer module according to the first identifier, the second identifier, and the third identifier that are acquired comprises:
searching for the first module layer module indicated by the first identifier;
searching for, in the first module layer module, the first control layer module indicated by the second identifier; and
invoking, in the first control layer module, the first function module indicated by the third identifier.

3. The method according to claim 2, wherein the invoking, in the first control layer module, the first function module indicated by the third identifier comprises:
invoking a second function module in a second control layer module located on the control layer according to indication information in the first function module, wherein the second control layer module belongs to the control layer modules in the first module layer module, and/or, the second control layer module belongs to a control layer module in a second module layer module located on the module layer.

4. The method according to claim 2, wherein the invoking, in the first control layer module, the first function module indicated by the third identifier comprises:
invoking a database in a DAO module located on a data layer according to indication information in the first function module, wherein data required for executing a service logic corresponding to the first function module is recorded in the database.

5. The method according to claim 1, wherein after processing of the allocating the request to the first function module in the first control layer module in the first module layer module according to the first identifier, the second identifier, and the third identifier that are acquired, the method further comprises:
invoking a display function module to output a result of the processing, wherein the display function module comprises at least one of the following: a JSON output module, an XML, output module, and a view output module.

6. The method according to claim 11, wherein before the request is received, the method further comprises:
setting one or more module layer modules located on the module layer, wherein the module layer modules comprise the first module layer module;
setting one or more control layer modules located on the control layer, wherein the control layer modules comprise the first control layer module; and
setting, in each of the control layer modules, one or more function modules, wherein each of the function modules corresponds to one or more service logics.

7. The method according to claim 6, wherein before the request is received, the method further comprises: setting the DAO module located on the data layer, wherein data required for executing the one or more service logics is recorded in the database stored in the DAO module.

8. The method according to claim 6, wherein different module layer modules correspond to different applications.

9. The method according to claim 6, further comprising:
receiving a function module modification request; and
modifying a service logic corresponding to a function module indicated by the function module modification request.

10. An apparatus for processing a request, comprising:
various units each of which constituted by processor-implemented instructions, the units comprising:
a first receiving unit, configured to receive a request, wherein the request carries a first identifier for indicating a first module layer module located on a module layer, a second identifier for indicating a first control layer module located on a control layer, and a third identifier for indicating a first function module in the first control layer module, wherein the first module layer module has one or more control layer modules that comprise the first control layer module;
an acquisition unit, configured to acquire the first identifier, the second identifier, and the third identifier from the request; and
a first invoking unit, configured to invoke the request and allocate the request to the first function module in the first control layer module in the first module layer module according to the first identifier, the second identifier, and the third identifier that are acquired.

11. The apparatus according to claim 10, wherein the first invoking unit comprises:
a first search module, configured to search for the first module layer module indicated by the first identifier;
a second search module, configured to search for, in the first module layer module, the first control layer module indicated by the second identifier; and
a first invoking module, configured to invoke, in the first control layer module, the first function module indicated by the third identifier.

12. The apparatus according to claim 11, wherein the first invoking module comprises:
a first invoking submodule, configured to invoke a second function module in a second control layer module located on the control layer according to indication information in the first function module, wherein the second control layer module belongs to the control layer modules in the first module layer module, and/or, the second control layer module belongs to a control layer module in a second module layer module located on the module layer.

13. The apparatus according to claim 11, wherein the first invoking module comprises:
a second invoking submodule, configured to invoke a database in a DAO module located on a data layer according to indication information in the first function module, wherein data required for executing a service logic corresponding to the first function module is recorded in the database.

14. The apparatus according to claim 10, further comprising:
a second invoking unit, configured to: after processing of the allocating the request to the first function module in the first control layer module in the first module layer module according to the first identifier, the second identifier, and the third identifier that are acquired, invoke a display function module to output a result of the processing, wherein the display function module comprises at least one of the following: a JSON output module, an XML output module, and a view output module.

15. The apparatus according to claim 10, further comprising:
a first setting unit, configured to: before the request is received, set one or more module layer modules located on the module layer, wherein the module layer modules comprise the first module layer module;
a second setting unit, configured to set one or more control layer modules located on the control layer, wherein the control layer modules comprise the first control layer module; and
a third setting unit, configured to set, in each of the control layer modules, one or more function modules, wherein each of the function module corresponds to one or more service logics.

16. The apparatus according to claim 15, comprising:
a fourth setting unit, configured to: before the request is received, set the DAO module located on the data layer, wherein data required for executing the one or more service logics is recorded in the database stored in the DAO module.

17. The apparatus according to claim 15, comprising:
a second receiving unit, configured to receive a function module modification request; and
a modification unit, configured to modify a service logic corresponding to a function module indicated by the function module modification request.
